(19) United States
(12) Patent Application Publication
(10) Pub. No.: US 2015/0136308 A1
(43) Pub. Date: May 21, 2015

(54) FIELD REPAIR KITS FOR STRUCTURAL PANEL

(71) Applicant: Sikorsky Aircraft Corporation, Stratford, CT (US)

(72) Inventors: Jonathan Bremmer, Glastonbury, CT (US); Christian A. Rogg, New Milford, CT (US); Jeffrey G. Sauer, Woodbury, CT (US); Darryl Mark Toni, Madison, CT (US); Allan R. Macallister, Jr., Milford, CT (US); William E. Hovan, III, Oxford, CT (US); Paul H. Denavit, Woodbridge, CT (US); Mihail Sirbu, Bridgeport, CT (US)

(73) Assignee: Sikorsky Aircraft Corporation, Stratford, CT (US)

(21) Appl. No.: 14/086,423

(22) Filed: Nov. 21, 2013

(51) Int. Cl. B29C 73/06; B29C 73/10; B32B 3/12

(52) U.S. Cl. CPC B29C 73/06; B32B 3/12; B29C 73/10; B32B 2305/024; B32B 2605/18
USPC 156/98; 428/414; 428/116; 428/77

(57) ABSTRACT

A kit for repairing an opening formed in a composite panel having a laminate skin arranged on opposing sides of a first core material is provided including a plug and a patch. The plug is formed from a second core material and has a cured filler material arranged within at least a portion of the second core material. The patch is formed from a plurality of cured first plies arranged in a stacked orientation. The plug is configured to be received within the opening of the composite panel and the patch is configured to cover the opening of the composite panel.

This invention was made with Government support under Agreement N00019-06-C-0081. The Government has certain rights in the invention.

### BACKGROUND OF THE INVENTION

Exemplary embodiments of the invention generally relate to a rotary wing aircraft, and more particularly, to a composite structural panel of a rotary wing aircraft.

Due to the favorable strength and weight characteristics of composite materials, the use of composites in various industries continues to expand. In aircraft manufacturing, the increasing use of composite material and composite structural assemblies is leading to significant improvements in fuel economy and substantial reduction of operating costs and atmospheric emissions. Currently, composite panels are used in the structural airframe of a rotary wing aircraft. These composite panels typically utilize a honeycomb core material having cured fiberglass or prepreg composite skins bonded thereto.

The composite panels in the airframe are commonly damaged during operation of the aircraft. Local damage may be repaired using a time consuming process that involves first curing a new piece of core material into the composite panel, and then secondly, curing a plurality of plies to patch the composite skin. Because the core material and composite skin are cured separately, the time required to repair the composite panel, and therefore the time that the rotary wing aircraft is non-operational, typically exceeds two days.

### BRIEF DESCRIPTION OF THE INVENTION

According to one embodiment of the invention, a kit for repairing an opening formed in a composite panel having a laminate skin arranged on opposing sides of a first core material is provided including a plug and a patch. The plug is formed from a second core material and has a cured filler material arranged within at least a portion of the second core material. The patch is formed from a plurality of cured first plies arranged in a stacked orientation. The plug is configured to be received within the opening of the composite panel and the patch is configured to cover the opening of the composite panel.

According to another embodiment of the invention, a method of repairing a damaged composite panel of a rotary wing aircraft is provided including removing the damaged portion of laminate skin and an adjacent first core material of the composite panel to form an opening. A pre-formed plug having a bonding material applied to a portion thereof is inserted within the opening. The pre-formed plug includes a second core material having a cured filler material arranged within the second core material. A pre-formed patch having a bonding material applied to a portion thereof is installed over the opening so that a portion of the patch overlaps the adjacent laminate skin. The bonding material of the patch and the plug is cured to couple the patch and plug to the composite panel.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1A is a side perspective view of an example of a rotary wing aircraft;

FIG. 1B is a perspective view of the rotary wing aircraft of FIG. 1A illustrating an upper surface which utilizes one or more composite panels;

FIG. 1C is a perspective view of the rotary wind aircraft of FIG. 1A illustrating a lower surface which utilizes one or more composite panels;

FIG. 2 is a cross-sectional view of a composite panel configured for use in an airframe of a rotary wing aircraft;

FIG. 3 is a cross-sectional view of a composite panel having a damaged portion of the panel removed;

FIG. 4A is a pre-formed repair kit for repairing a damaged portion of a composite panel according to an embodiment of the invention;

FIG. 4B is a pre-formed repair kit for repairing a damaged portion of a composite panel according to another embodiment of the invention;

FIG. 5 is a pre-formed repair kit installed within a damaged portion of a composite panel according to an embodiment of the invention; and

FIG. 6 is a block diagram schematically illustrating a method of repairing the damaged portion of a composite panel with a pre-formed repair kit according to an embodiment of the invention.

The detailed description explains embodiments of the invention, together with advantages and features, by way of example with reference to the drawings.

### DETAILED DESCRIPTION OF THE INVENTION

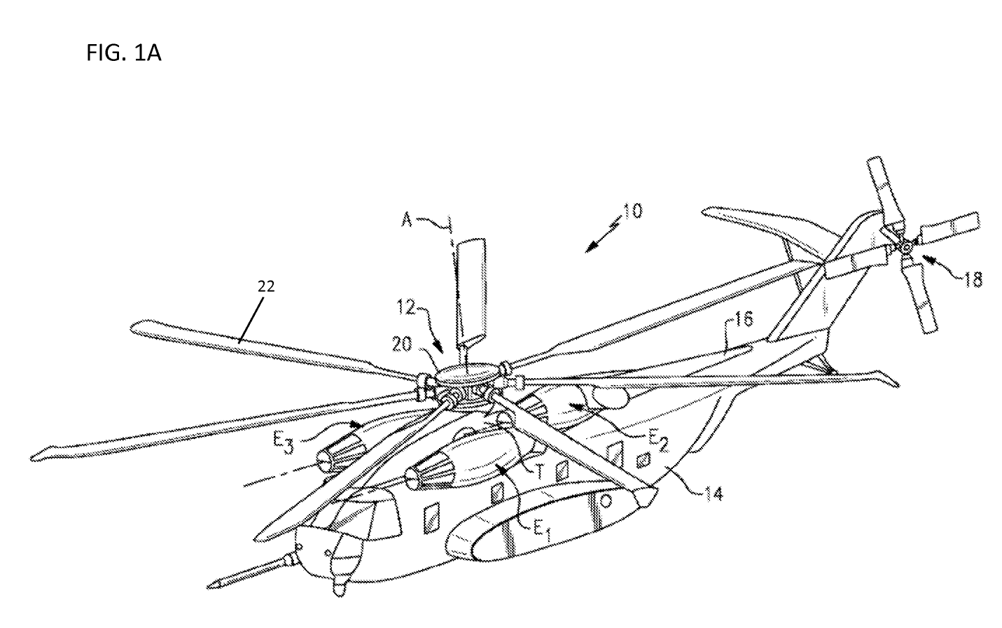

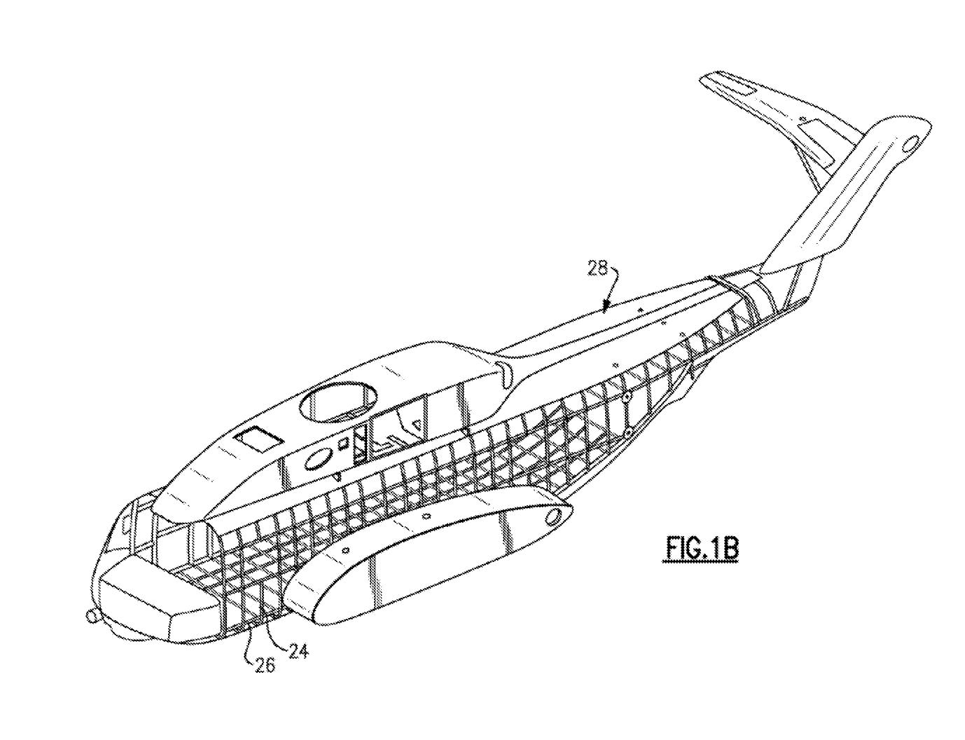

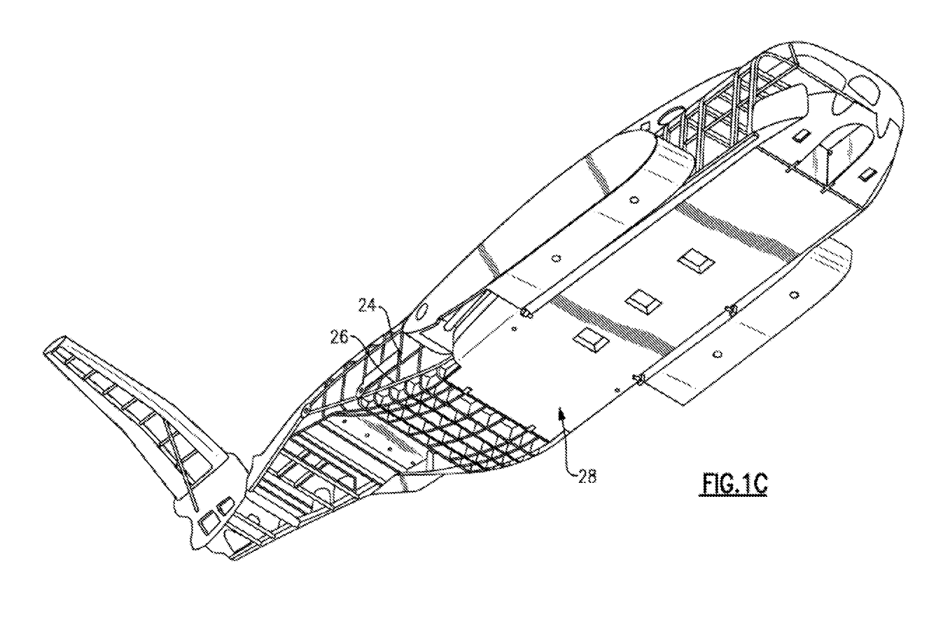

FIG. 1A schematically illustrates a rotary-wing aircraft 10 having a main rotor system 12. The aircraft 10 includes an airframe 14 having an extending tail 16 which mounts a tail rotor system 18, such as an anti-torque system for example. The main rotor assembly 12 is driven about an axis of rotation A through a main gearbox (illustrated schematically at T) by one or more engines E. The main rotor system 12 includes a plurality of rotor blades 22 mounted to a rotor hub 20. Although a particular helicopter configuration is illustrated and described in the disclosed non-limiting embodiment, other configurations and/or machines, such as high speed compound rotary wing aircraft with supplemental translational thrust systems, dual contra-rotating coaxial rotor system aircraft, turboprops, tilt-rotors, and tilt-wing aircraft, will also benefit from the present invention.

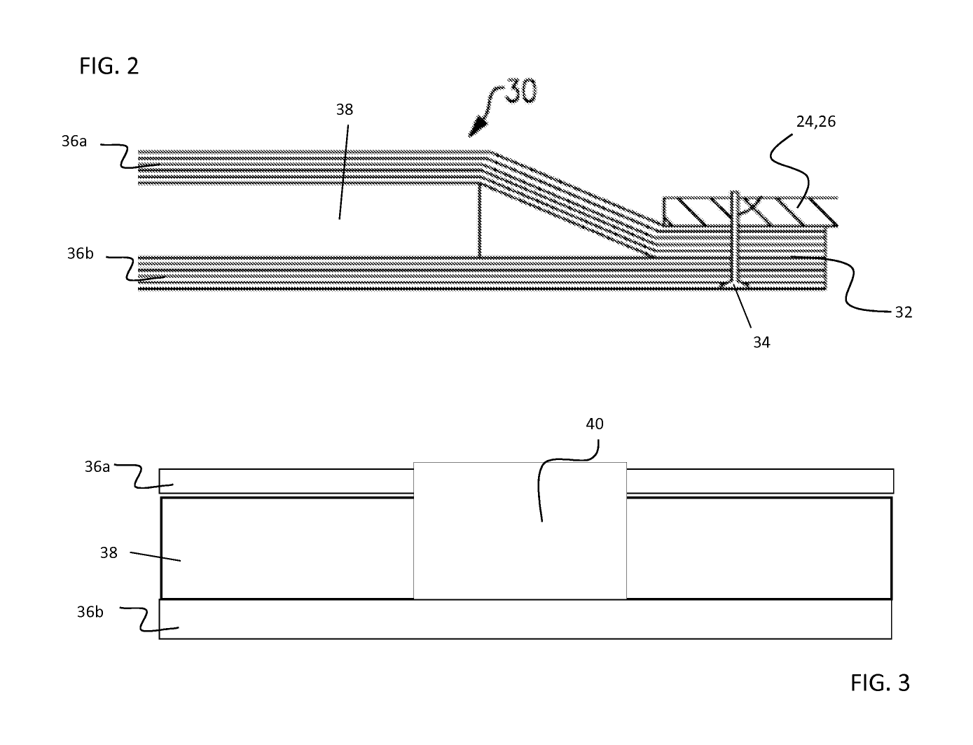

Referring now to FIGS. 1B and 1C, the airframe 14, may include a multitude of frame members 24 and a multitude of beam members 26 which support an aircraft outer skin 28 formed from a plurality of composite panels 30 (FIG. 2). The frame members 24 and beam members 26 may be arranged in a generally rectilinear pattern, however, any arrangement may be used as the composite panels 30 provide the rigidity necessary to reduce or eliminate the necessity of stringers. The composite panels 30 may be utilized in maintenance walkway areas, such as aircraft upper surfaces (FIG. 1B), high impact areas such as aircraft undersurfaces (FIG. 1C), as well as other areas such as wheel wells, floors, and steps of a rotary wing aircraft 10.

Referring now to FIG. 2, a cross-section of a portion of a composite panel 30 is illustrated in more detail. The composite panel 30 may include a flange edge 32 configured to mechanically attach, such as with fasteners 34 for example, to the frame members 24 and/or beam members 26 of the airframe 14. Each composite panel 30 includes multiple layers bonded together. The panel 30 includes a first laminate skin 36a and a second, similar laminate skin 36b arranged adjacent opposing sides of a core material 38. Each laminate skin 36 includes multiple plies, for example having graphite, fiberglass, or carbon fibers. The core material 38 may be a low density honeycomb core, such as the Kevlar® core material manufactured by DuPont™ Advanced Fibers Systems of Richmond, Va., USA, or may include an advanced core material such as K-COR™ or X-COR™ manufactured by Albany Engineered Composites of Mansfield, Mass., USA.

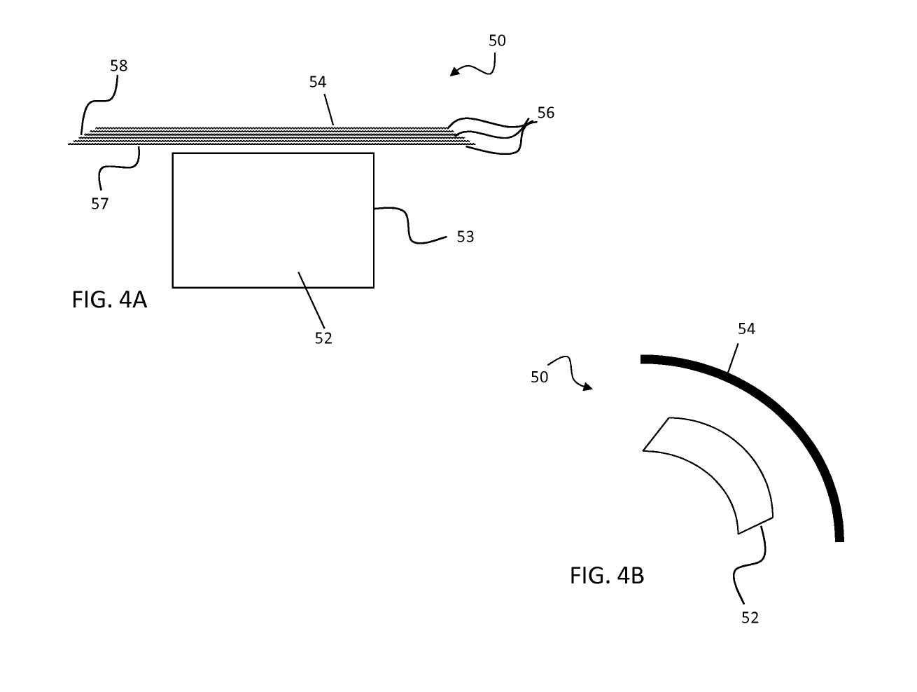

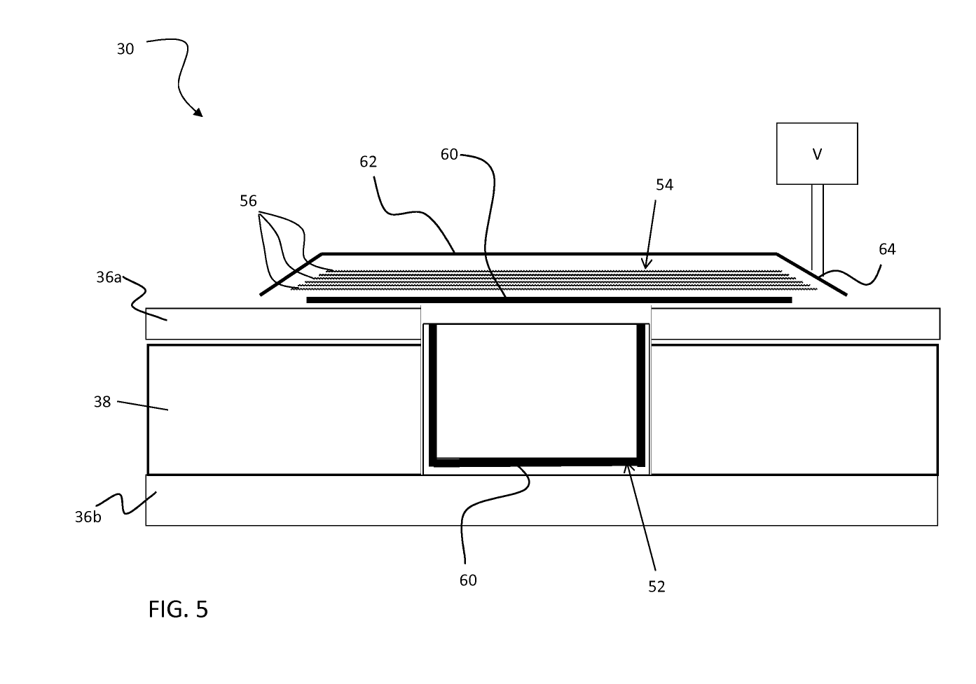

A damaged composite panel 30 can be repaired, rather than replaced, by removing the locally damaged portion of the laminate skin 36 and the adjacent portion of damaged core material 38 to form one or more openings 40 in the composite panel 30 (FIG. 3). Referring now to FIGS. 4 and 5, a pre-formed kit 50 including a plug 52 and patch 54 may be used to repair each of the openings 40 created in the composite panel 30. In embodiments where the composite panel 30 has multiple openings 40 of different sizes, multiple repair kits 50 having plugs 52 and patches 54 of various sizes and shapes may be applied.

The pre-formed plug 52 includes a material, for example a low density honeycomb core material that can be substantially identical to the core material 38 of the composite panel 30. In one embodiment, the material of the plug 52 has been pre-densified by curing the plug 52 after the openings (not shown) in the material of the plug 52 are filled with a filler material, such as EPOCAST® epoxy for example. The size and shape of the plug 52 is similar to at least one opening 40 formed in the core material 38, and therefore to the portion of the core material 38 removed from the composite panel 30. Although a plug 52 having a generally rectangular cross-section is illustrated, plugs 52 having any shape or cross-section are within the scope of the invention. When installed within the composite panel 30, the plug 52 may be generally arranged within a plane (FIG. 5). However, in some embodiments, the plug 52 has a generally non-planar contour, such as a radius for example, that is generally complementary to the remainder of the composite panel 30.

Similar to the laminate skin 36, the patch 54 includes multiple stacked plies 56 cured to form a patch 54 having a thickness substantially equal to the thickness of the laminate skin 36 of the composite panel 30. The material of the plies 56 used to form the patch 54 can be similar or identical to the plies used to form the laminate skin 36. The size of the patch 54 can be substantially larger than the opening 40 formed in the skin over which the patch 54 is being applied. The patch 54 is configured to cover the opening 40 and overlap the adjacent laminate skin 36 about the entire periphery of the opening 40. In one embodiment, the length and width of each ply 56 in the patch 54 varies such that the portion of each ply 56 that overlaps the adjacent laminate skin 36 differs dimensionally from that of another ply 56 in the patch 54. As a result, the patch 54 can have a generally feathered or tapered edge 58.

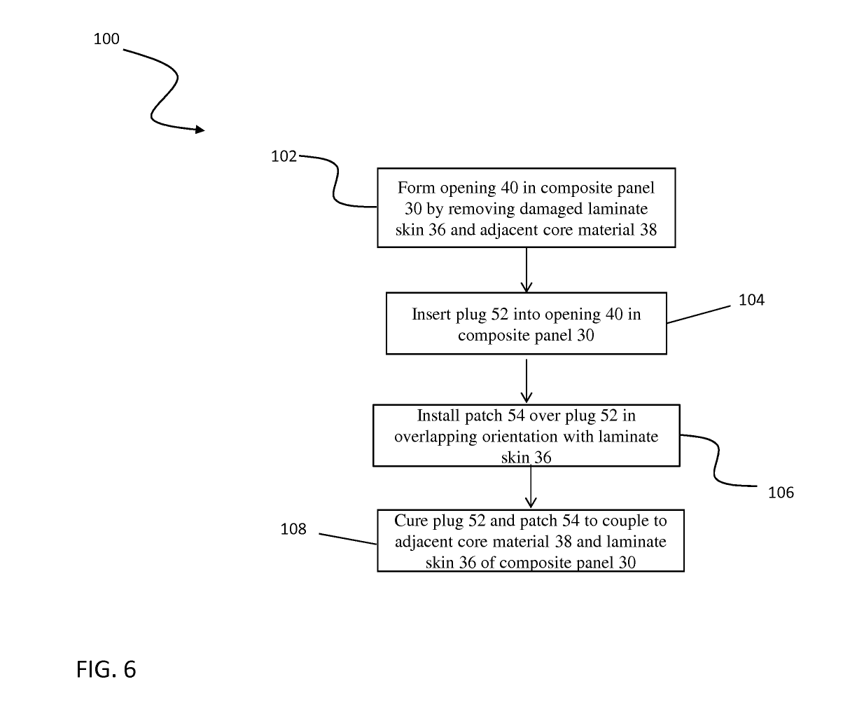

Referring now to FIG. 5 and FIG. 6, a method 100 of repairing a damaged composite panel 30 using a pre-formed kit 50 is illustrated. In block 102, a damaged portion of the laminate skin 36 and core material 38 are removed to form an opening 40 in the composite panel 30. A plug 52 of the repair kit 50, having a bonding material 60 applied about its outer periphery 53, is inserted into an opening 40 in the composite panel 30 in block 104. In block 106, the patch 54 of the repair kit 50, similarly having a bonding material 60 applied thereto, is arranged generally centrally over the plug 52 in an overlapping orientation with the adjacent laminate skin 36. In one embodiment, the bonding material 60 is applied to the underside of the patch 54, or the surface of the patch 54 configured to contact the plug 52 and the laminate skin 36. The plug 52 and patch 54 are cured in block 108 to couple the plug 52 and patch 54 with the adjacent core material 38 and laminate skin 36. To cure the patch 54 and plug 52, a vacuum bagging film 62 is placed around the patch 54 and is secured to the surface of the laminate skin 36. A port 64 extends through the bagging film 62 and is configured to connect to a vacuum pump, illustrated schematically at V, which applies a uniform pressure over the patch 54.

The process of repairing a damaged portion of a composite panel 30 in an aircraft 10 is simplified by using the pre-fabricated plug 52 and patch 54 of the repair kit 50. Because the plug 52 and patch 54 in the kit 50 are ready for assembly, only a structural epoxy adhesive and low pressure are required to cure the plug and patch to the composite panel. This can result in a significant time reduction for the repair of each composite panel, as compared with other repair processes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A kit for repairing an opening formed in a composite panel having a laminate skin arranged on opposing sides of a first core material, the kit comprising:
a plug formed from a second core material and having a cured filler material arranged within at least a portion of the second core material, the plug being configured to be received within the opening; and
a patch formed from a plurality of cured first plies arranged in a stacked orientation, the patch being configured to cover the opening.

2. The kit according to claim 1, wherein the second core material is substantially identical to the first core material.

3. The kit according to claim 1, wherein the second core material is a low density honeycomb core.

4. The kit according to claim 1, wherein a shape and size of the plug is substantially complementary to the opening formed in the composite panel.

5. The kit according to claim 1, wherein the plug is configured to fit within the opening and bond to one or more adjacent portions of the first core material.

6. The kit according to claim 1, wherein the laminate skin includes a plurality of second plies and the plurality of cured first plies are similar to the plurality of second plies of the laminate skin.

7. The kit according to claim 1, wherein the patch is configured to overlap the laminate skin about a periphery of the opening in the composite panel.

8. The kit according to claim 1, wherein at least one of the plurality of cured first plies has at least one of a length and width that differs from that of a remainder of the plurality of cured first plies.

9. The kit according to claim 7, wherein the plurality of cured first plies of the patch form a tapered edge.

10. A method of repairing a damaged portion of a composite panel of a rotary wing aircraft, comprising:
removing a damaged portion of laminate skin and an adjacent first core material of the composite panel to form an opening;
inserting a pre-formed plug having a bonding material applied to a portion thereof within the opening, the pre-formed plug including a second core material having a cured filler material arranged within the second core material;
installing a pre-formed patch having a bonding material applied to a portion thereof over the opening such that a portion of the patch overlaps the adjacent laminate skin; and
curing the bonding material of the patch and the plug to couple the patch and the plug to the composite panel.

11. The method according to claim 10, wherein the pre-formed plug has a size and shape complementary to the opening formed in the composite panel.

12. The method according to claim 10, wherein the second core material is a low density honeycomb core.

13. The method according to claim 10, wherein the bonding material is applied to an outer periphery of the plug.

14. The method according to claim 10, wherein the bonding material is applied to an underside of the patch.

15. The method according to claim 10, wherein the patch is installed generally centrally over the opening in the composite panel.

16. The method according to claim 10, wherein the bonding material is cured by applying low pressure to the patch and the plug.

17. The method according to claim 16, wherein pressure is applied to the patch and the plug using a vacuum.
